(19) United States
(12) Patent Application Publication
(10) Pub. No.: US 2021/0276427 A1
(43) Pub. Date: Sep. 9, 2021

(54) VEHICLE EQUIPPED WITH BRAKE SYSTEM AND DRIVE SYSTEM

(71) Applicant: TOYOTA JIDOSHA KABUSHIKI KAISHA, Toyota-shi (JP)

(72) Inventors: Naoki YAMAMOTO, Okazaki-shi (JP); Satoshi MURATA, Miyoshi-shi (JP)

(73) Assignee: TOYOTA JIDOSHA KABUSHIKI KAISHA, Toyota-shi (JP)

(21) Appl. No.: 17/143,336

(22) Filed: Jan. 7, 2021

(30) Foreign Application Priority Data
Mar. 6, 2020 (JP) 2020-038861

(51) Int. Cl. B60L 7/26; B60L 15/20

(52) U.S. Cl. CPC B60L 7/26; B60L 7/14; B60L 15/2009

(57) ABSTRACT

A vehicle includes: two front wheels which are front right and left wheels and two rear wheels which are rear right and left wheels; a brake system capable of applying a braking force to only one of (a) the two front wheels and (b) two rear wheels, independently of each other utilizing a friction force; and a drive system configured to drive at least the other of (a) the two front wheels and (b) the two rear wheels by a force of electric, motors, each as a drive source, respectively corresponding to the other of (a) the two from wheels and (b) the two rear wheels, the drive system being capable of applying a braking force to at least the other of (a) the two front wheels and (b) the two rear wheels, independently of each other utilizing regeneration by the electric motors.

### CROSS REFERENCE TO RELATED APPLICATION

The present application claims priority to Japanese Patent Application No. 2020-038861, which was filed on Mar. 6, 2020, the disclosure of which is herein incorporated by reference in its entirety.

### BACKGROUND

### Technical Field

The present disclosure relates to a vehicle equipped with a brake system and a drive system.

### Description of Related Art

Ordinary vehicles having four wheels, i.e., front right and left wheels and rear right and left wheels, are conventionally equipped with friction brake devices provided for the respective four wheels. Each friction brake device typically includes a rotation body, such as a disc rotor, configured to rotate with the wheel, a friction member, such as a brake pad, configured to be pushed against the rotation body, and an actuator configured to push the friction member against the rotation body. As described in Japanese Patent Application Publication No. 2013-135532, there has been recently proposed employing, in electric vehicles, a regenerative brake, i.e., a brake utilizing energy regeneration by an electric motor as a drive source of the vehicle, in place of the friction brake device.

### SUMMARY

The friction brake device has a long history of use and is excellent in reliability whereas it has structural limitations because some constituent components are disposed in a rim of the wheel. On one hand, the regenerative brake can be achieved only by a drive system without needing any special constituent component for generating a braking force. The regenerative brake, however, is disadvantageous in that it cannot generate a large braking force. It is therefore possible to improve utility of the vehicle by making some modifications to the combination of the friction brake device and the regenerative brake. Accordingly, one aspect of the present disclosure is directed to a vehicle having high utility.

In one aspect of the present disclosure, a vehicle includes: two front wheels which are front right and left wheels and two rear wheels which are rear right and left wheels; a brake system capable of applying a braking force to only one of (a) the two front wheels and (b) the two rear wheels, independently of each other utilizing a friction force; and a drive system configured to drive at least the other of (a) the two front wheels and (b) the two rear wheels by a force of electric motors, each as a drive source, respectively corresponding to the other of (a) the two front wheels and (b) the two rear wheels, the drive system being capable of applying a braking force to at least the other of (a) the two front wheels and (b) the two rear wheels, independently of each other utilizing regeneration by the electric motors.

The brake system includes a friction brake device. The drive system achieves regenerative brake. In the vehicle according to the present disclosure, the friction brake device is provided for only one of: the front wheels; and the rear wheels, and the regenerative brake is employed for at least the other the front wheels; and the rear wheels. The friction brake device is not provided for all of the four wheels, but is provided only for each of the two wheels. Thus, the vehicle as a whole is less likely to he subject to structural limitations on the braking-force generating means. Conversely, the friction brake device is provided for each of the two wheels, so that the reliability of the braking-force generating means can be ensured. Further, the regenerative brake can be applied to at least the wheels for each of which the friction brake device is not provided, so that a request for a relatively large braking force can be adequately responded to in the vehicle of the present disclosure.

### Various Forms

In view of the fact that the reliability of the friction brake device is high and the friction brake device can apply a relatively large braking force, it is preferable that the one of: the front wheels; and the rear wheels, to which the brake system applies the braking force, be the front wheels. From the viewpoint of simplifying the structure of the vehicle, the drive system preferably drives only the other of: the front wheels; and the rear wheels to which the braking force is not applied by the brake system. That is, it is preferable to apply the braking force by regeneration to only the other of: the front wheels; and the rear wheels.

From the viewpoint of applying the regenerative braking force to the wheels, the drive system preferably includes a plurality of wheel drive devices of an in-wheel motor type each of which is provided for a corresponding one of the wheels driven by the drive system and in each of which the electric motor is disposed in a rim of the corresponding one of the wheels driven by the drive system. Specifically, unlike a drive device whose electric motor is installed on a body of the vehicle, the in-wheel-motor-type wheel drive device does not need a relatively long drive shaft and is excellent in response in an antilock brake operation (ABS operation) performed with respect to the regenerative brake.

In a case where the brake system includes two wheel brake devices corresponding to the right and left wheels to which the braking force is applied by the brake system, each of the two wheel brake devices preferably include: a rotation body that rotates with the wheel; a friction member configured to be pushed against the rotation body; and a brake actuator held by a carrier that rotatably holds the wheel and including a piston, the brake actuator being configured to advance the piston so as to push the friction member against the rotation body.

The brake actuator may be an electric brake actuator including an electric motor as a drive source and a motion converting mechanism configured to convert a rotating motion of the electric motor into an advancing and retracting motion of the piston. That is, the wheel brake device may be the electric brake device configured such that the friction member is pushed against the rotation body by a force of the electric motor. The electric brake device is excellent in response to a request for the braking, force, i.e., the braking-force request.

The brake actuator may be a hydraulic brake actuator including a hydraulic cylinder configured to advance the piston by a pressure of a working fluid supplied to the hydraulic cylinder. In this instance, the brake system may include a working-fluid supply device that includes a hydraulic pressure source and that is configured to supply the working fluid from the hydraulic pressure source to the hydraulic cylinders of the hydraulic brake actuators of the two wheel brake devices and to individually adjust the pressures of the working fluid supplied to the hydraulic cylinders. That is, the hydraulic brake system with relatively high reliability can be employed as the brake system. In a case where the hydraulic brake system is employed, the hydraulic brake system preferably includes a brake operation member to be operated by a driver and is preferably configured such that, in the event of an electric failure or the like of the working-fluid supply device, the working fluid to be supplied to the hydraulic cylinders is pressurized by a force applied to the brake operation member by the driver, from the viewpoint of failsafe.

With regard to generation of the braking force by the regenerative brake of the drive system (hereinafter referred to as “regenerative braking force” where appropriate) and the braking force by the brake system (hereinafter referred to as “friction braking force” where appropriate), the braking force by the drive system, namely, the regenerative braking force, is preferably generated with higher priority in response to a braking force request to the vehicle, and an insufficient braking force, which is a shortage not provided by the braking force generated by the drive system, is preferably compensated for by the braking force generated by the brake system, namely, by the friction braking force, in terms of energy saving of the vehicle.

Each of the brake system and the drive system can apply the braking force individually to the plurality of wheels to which each of the brake system and the drive system should apply the braking force. Thus, the present vehicle is configured such that, in a case where the wheel locks in a state in which the braking force is being applied thereto, the ABS operation can be performed on that locking wheel irrespective of which one of the four wheels (the front right and left wheels and the rear right and left wheels) the locking wheel is. Specifically, in a case where the wheel locks in a state in which the braking force is being applied to the wheel, one of the brake system and the drive system can perform the ABS operation when the one of the brake system and the drive system is applying the braking force to the wheel and both the brake system and the drive system can perform the ABS operation when both the brake system and the drive system are applying the braking force to the wheel.

### BRIEF DESCRIPTION OF THE DRAWINGS

The objects, features, advantages, and technical and industrial significance of the present disclosure will be better understood by reading the following detailed description of embodiments, when considered in connection with the accompanying drawings, in which:

FIG. 1 is a schematic view illustrating an overall structure of a vehicle according to a first embodiment;

FIG. 2 is a perspective view of a wheel mounting module including a front wheel drive device and a wheel brake device;

FIG. 3 is a view of the wheel brake device;

FIG. 4 is a cross-sectional view of a brake actuator of the wheel brake device;

FIG. 5 is a view of a rear-wheel drive device;

FIG. 6 is a flowchart indicating a central drive control program executed in the vehicle according to the first embodiment;

FIG. 7 is a flowchart indicating a central brake control program executed in the vehicle according to the first embodiment;

FIG. 8 illustrates flowcharts indicating a wheel drive control program and a wheel brake control program executed in the vehicle according to the first embodiment;

FIG. 9 is a schematic view illustrating an overall structure of a vehicle according to a second embodiment;

FIG. 10A is a hydraulic circuit diagram of a brake system of the vehicle according to the second embodiment;

FIG. 10B is a cross-sectional view illustrating an outline structure of a wheel brake device of the brake system of FIG. 10A;

FIG. 11 is a flowchart indicating a brake control program executed in the vehicle according to the second embodiment;

FIG. 12 is a schematic view illustrating an overall structure of a vehicle according to a third embodiment;

FIG. 13 is a schematic view illustrating an overall structure of a vehicle according to a fourth embodiment;

FIG. 14 is a schematic view illustrating an overall structure of a vehicle according to a first modification;

FIG. 15 is a schematic view illustrating an overall structure of a vehicle according to a second modification;

FIG. 16 is a schematic view illustrating an overall structure of a vehicle according to a third modification; and

FIG. 17 is a schematic view illustrating an overall structure of a vehicle according to a fourth modification.

### DETAILED DESCRIPTION OF THE EMBODIMENTS

Referring to the drawings, there will be explained below in detail vehicles according to embodiments of the present disclosure and modifications thereof. It is to be understood that the present disclosure is not limited to the details of the following embodiments but may be embodied based on the forms described in Various Forms and may be changed and modified based on the knowledge of those skilled in the art. Each of the vehicles according to the embodiments and the modifications is a vehicle having four wheels, i.e., front right and left wheels and rear right and left wheels. In the following explanation, the four wheels are represented as a front left wheel 10FL, a front right wheel 10FR, a rear left wheel 10RL, and a rear right wheel 10RR, respectively. When it is not necessary to distinguish right and left wheels from each other, each of the front left wheel 10FL and the front right wheel low is represented as “front wheel 10F” and each of the rear left wheel 10RL and the rear right wheel 10RR is represented as “rear wheel 10R”. When it is not necessary to distinguish the four wheel from each other, each of the front left wheel 10FL, the front right wheel 10FR, the rear left wheel 10RL, and the rear right wheel 10RR is represented as “wheel 10”.

### First Embodiment

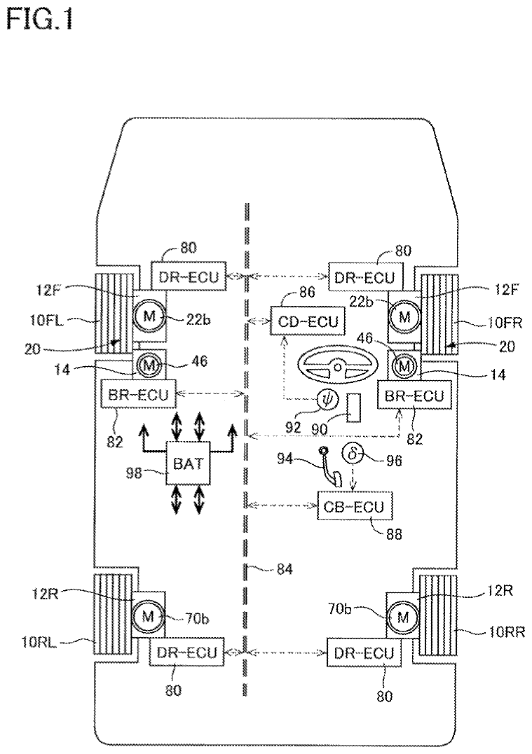

As schematically illustrated in FIG. 1, the vehicle according to the first embodiment includes: a drive system including four wheel drive devices 12 configured to drive the respective four wheels 10; and a brake system including two wheel brake devices 14 configured to brake the respective front right and left wheels 10F. It is noted that each of the two wheel drive devices 12 corresponding to the two front wheels 10F will be referred to as a front-wheel drive device 12F where appropriate and each of the two wheel drive devices 12 corresponding to the two rear wheels 10R will be referred to as a rear-wheel drive device 12R where appropriate.

### i) Hardware Structure on Front-Wheel Side

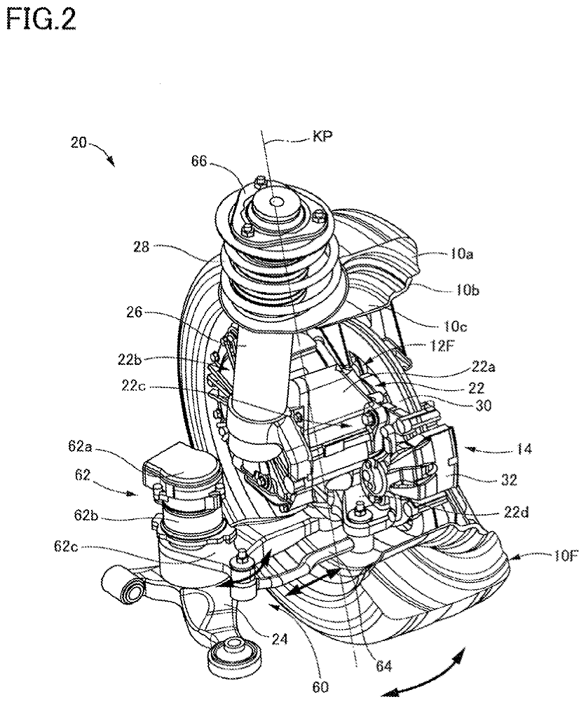

The front-wheel drive device 12F and the wheel brake device 14 are incorporated in a wheel mounting module 20 (hereinafter simply referred to as “module 20” where appropriate) illustrated in FIG. 2. The module 20 is for mounting, on a body of the vehicle, a wheel 10b to which a tire 10a is attached. Though the wheel 10b itself may be regarded as the wheel 10, the wheel 10b to which the tire 10a is attached is referred to as the wheel 10 in the present embodiment for convenience sake.

The front-wheel drive device 12F includes, as its main element, a wheel drive unit 22. The wheel drive unit 22 includes: a housing 22a; a drive motor 22b that is an electric motor as a drive source and a speed reducer 22c configured to reduce rotation of the drive motor 22b (both the drive motor 22b and the speed reducer 22c are housed in the housing 22a and are not illustrated in FIG. 2); and an axle hub to which the wheel 10b is attached. (The axle hub is hidden in FIG. 2.). The wheel drive unit 22 is what is called in-wheel motor unit disposed inside a rim 10c of the wheel 10b. The front-wheel drive device 12F is a wheel drive device of an in-wheel motor type. The wheel drive unit 22 is well known and its explanation is dispensed with.

By supplying an electric current to the drive motor 22b, the front-wheel drive device 12F drives the front wheel 10F with a drive force whose magnitude corresponds to an amount of the supplied electric current. There is generated, in the drive motor 22b, an electric current based on an electromotive force generated by rotation of the front wheel 10F. By recovering the generated electric current to the power source, namely, by energy regeneration, a braking force to stop the rotation a the front wheel 10F (hereinafter referred to as “wheel rotation braking force” where appropriate) can be applied to the front wheel 10F, in other words, by utilizing the drive motor 22b as the generator, the front-wheel drive device 12F functions also as a wheel regenerative brake device.

The module 20 includes a MacPherson-type suspension device (also referred to as a MacPherson strut type suspension device). In the suspension device, the housing 22a of the wheel drive unit 22 functions as a carrier which rotatably holds the wheel and which is allowed to move upward and downward relative to the vehicle body. Further, the housing 22a functions as a steering knuckle of a wheel steering device that will be later explained. The suspension device is constituted by a lower arm 24 as a suspension arm, the housing 22a of the wheel drive unit 22, a shock absorber 26, and a suspension spring 28. The suspension device has an ordinary structure and its detailed explanation is dispensed with.

The wheel brake device 14 includes: a disc rotor 30, as a rotation body, attached to the axle hub together with the wheel 10b so as to rotate together with the wheel 10; and a brake caliper 32 held by the housing 22a of the wheel drive unit 22 so as to straddle the disc rotor 30. The brake caliper 32 includes: brake pads each as a friction member; and a brake actuator including an electric motor and configured to push the brake pads by a force of the electric motor against the disc rotor 30 for stopping the rotation of the wheel 10.

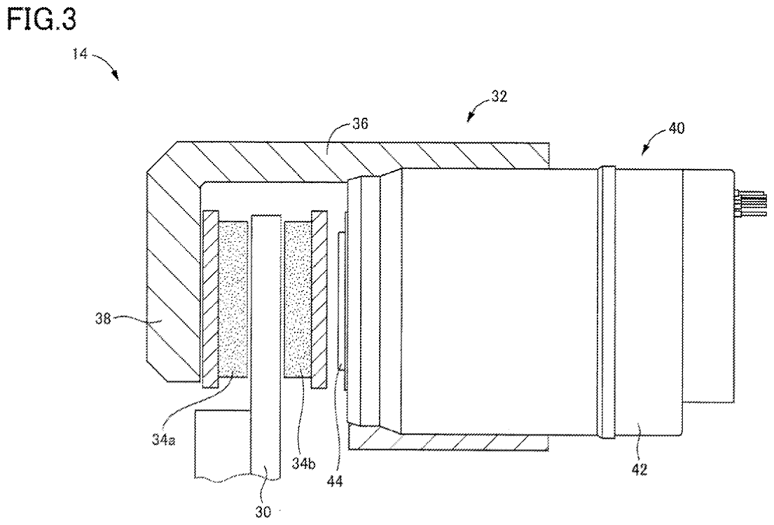

Referring to FIG. 3, the wheel brake device will be explained in detail. The brake caliper 32 (hereinafter simply referred to as “caliper 32” where appropriate) is held by a mount provided on the housing 22a of the wheel drive unit 22, such that the caliper 32 is movable in the axial direction (i.e., the right-left direction in FIG. 2) and such that the caliper 32 straddles the disc rotor 30. The brake pads 34a, 34b (hereinafter simply referred to as “pads 34a, 34b” where appropriate) are held by the mount such that the disc rotor 30 is interposed therebetween in a state in which the pads 34a, 34b are movable in the axial direction.

For the sake of convenience, the left side and the right side in FIG. 2 are referred to as a front side and a rear side, respectively. The pad 34a located on the front side is supported by a front end portion (claw portion) 38 of a caliper main body 36. The brake actuator 40 (hereinafter simply referred to as “actuator 40” where appropriate) is held by a rear-side portion of the caliper main body 36 such that a housing 42 of the actuator 40 is fixed to the rear-side portion of the caliper main body 36. The actuator 40 includes a piston 44 held by the housing 42 so as to be advanceable and retractable. When the piston 34 advances, a distal end portion of the piston 44 comes into engagement with the pad 34b located on the rear side. When the piston 44 further advances while being kept engaged with the rear-side pad 34b, the pads 34a, 34b are pushed against the disc rotor 30 such that the disc rotor 30 is sandwiched by and between the pads 34a, 34b. Owing to the pushing by the pads 34a, 34b, there is generated a wheel friction braking force that is a braking, force for stopping the rotation of the wheel in dependence on a friction force between the disc rotor 30 and the pads 34a, 34b, in other words, there is generated a braking force for reducing the speed of the vehicle or stopping the vehicle.

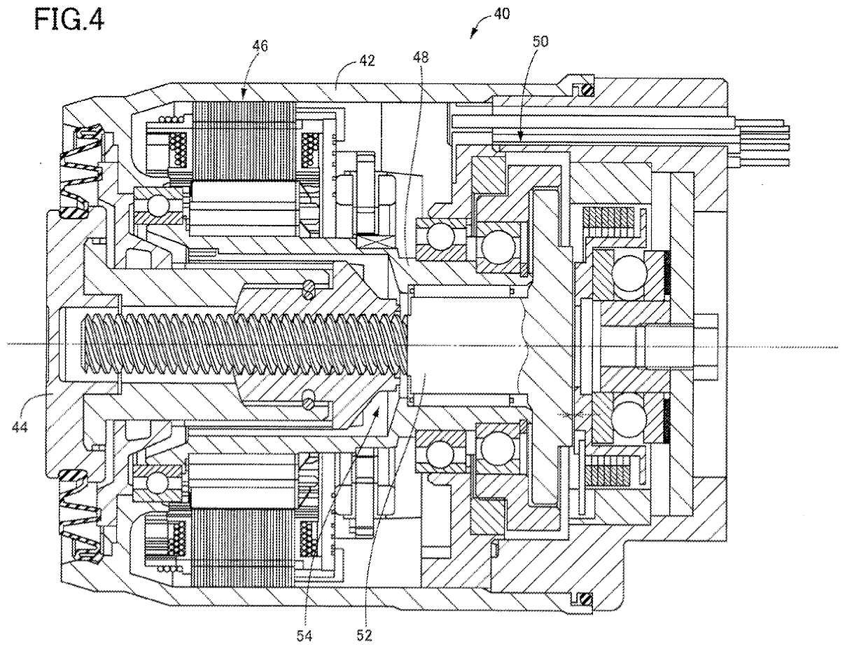

The actuator 40 will be briefly explained referring to a cross-sectional view of FIG. 4. The actuator 40 is an electric brake actuator. The actuator 40 includes, in addition to the housing 42 and the piston 44 described above, a brake motor 46 that is an electric motor as a drive source, a speed reduction mechanism 50 for decelerating rotation of the brake motor 46, specifically, rotation of a hollow motor shaft 48, and a motion converting mechanism 54 including a rotational shall 52 configured to be rotated by the rotation of the brake motor 46 decelerated by the speed reduction mechanism 50. The motion converting mechanism 54 is configured to convert the rotating motion of the rotational shaft 52 into an advancing and retracting motion of the piston 44. The piston 44 advances and retracts by controlling a supply current to the brake motor 46. The magnitude of the pushing force of the pads 34a, 34b against the disc rotor 30, namely, the magnitude of the wheel friction braking force, is proportional to the amount of the supplied electric current. In this respect, the speed reduction mechanism 50 is a differential speed reduction mechanism including two internally meshing planetary gear mechanisms that are disposed in series. The motion converting mechanism 54 is a screw mechanism. The wheel brake device 14 is an electric brake device including the electric brake actuator 40 and is excellent in response. That is, in the wheel brake device 14, a delay of generation of an actual braking force with respect to the braking force request is small.

The front wheel 10F is a steerable wheel. In addition to the front-wheel drive device 12F and the wheel brake device 14, a wheel steering device 60 is incorporated in the module 20, as illustrated in FIG. 2. The wheel steering device 60 includes a steering actuator 62 fixed to the lower arm 24, a tie rod 64, and a knuckle arm 22d extending from the housing 22a of the wheel drive unit 22. The steering actuator 62 includes a steering motor 62a that is an electric motor as a drive source, a speed reducer 62b for decelerating rotation of the steering motor 62a, and an actuator arm 62c configured to be pivoted by the rotation of the steering motor 62a decelerated by the speed reducer 62b and functioning as a pitman arm. The tie rod 64 connects the actuator arm 62c and the knuckle arm 22d. When the steering motor 62a is activated, the actuator arm 62c is pivoted as indicated by a bold arrow in FIG. 2, and the pivotal movement of the actuator arm 62c is transmitted by the tie rod 64, so that the front wheel 10F is steered about a kingpin axis KP.

In the present embodiment, the wheel drive device 12, the wheel brake device 14, and the wheel steering device 60 are incorporated in the module 20, namely, the wheel drive device 12, the wheel brake device 14, and the wheel steering, device 60 are modularized. Thus, a work of mounting the wheel drive device 12, the wheel brake device 14, and the wheel steering device 60 on the vehicle body can be easily performed. That is, a proximal end portion of the lower arm 24 is attached to a side member of the vehicle body, and an upper support 66 that constitutes the shock absorber 26 and an upper portion of the suspension spring 28 is attached to a tire housing of the vehicle body, whereby the module 20 can be mounted on the vehicle, in other words, the wheel drive device 12, the wheel brake device 14, and the wheel steering device 60 can be simultaneously mounted on the vehicle. Thus, the module 20 is excellent in mountability on the vehicle.

The wheel brake device 14 that is the friction brake device has been typically used over a long period of time and has high reliability. In the present vehicle, the friction brake device is provided not for the rear wheels 10R but for the front wheels 10F. In other words, the friction brake device is provided for one of: the front wheels; and the rear wheels, thus ensuring the reliability of the braking-force generating means in the vehicle as a whole.

The front-wheel drive device 12F is a wheel drive device of an in-wheel motor type and functions also as a wheel regenerative brake device. In a wheel drive device whose drive motor is installed on the vehicle body, the drive motor and the axle hub are connected by a relatively long drive shaft. In such a device, the drive shaft is one cause for a delay in response due to torsional elasticity, in an ABS operation relating to a regenerative braking force that will be later explained. That is, when the regenerative braking force is cancelled or when the regenerative braking force is generated, the torsional elasticity inhibits prompt cancellation or prompt generation of the regenerative braking force. As apparent from the drawings, the present vehicle does not include the drive shaft. Thus, the ABS operation by the front-wheel drive device 12F is excellent in response.

### ii) Hardware Structure on Rear-Wheel Side

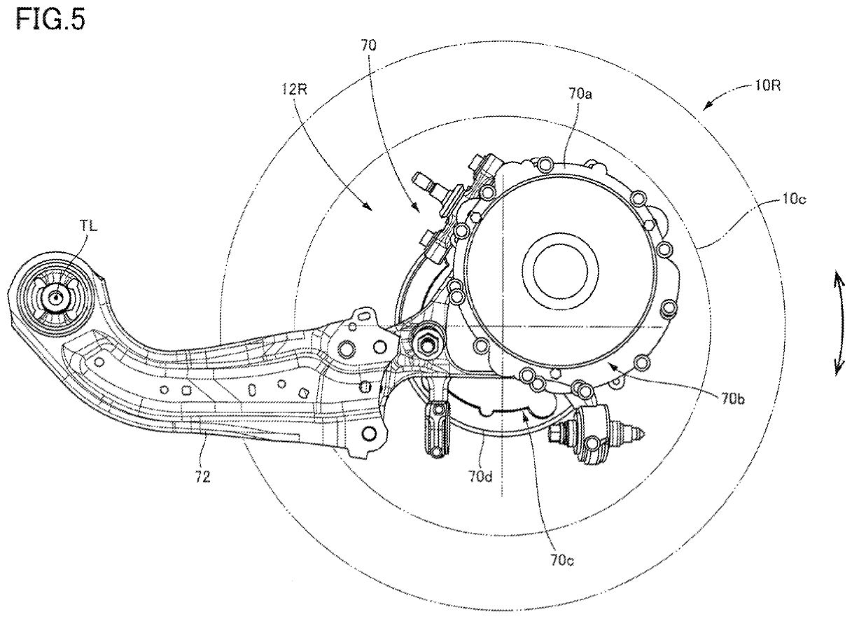

A suspension device of a trailing arm type is provided for each rear wheel 10R. As illustrated in FIG. 5, a wheel drive unit 70, which is a main constituent element of the rear-wheel drive device 12R, is fixed to a rear end portion of a trailing arm 72. The trailing arm 72 is supported at a front end portion thereof to the vehicle body so as to be pivotable about a pivot axis TL that extends in a width direction of the vehicle. FIG. 5 omits illustration of other constituent elements of the suspension device such as a suspension spring and a shock absorber.

Like the wheel drive unit 22 explained above, the wheel drive unit 70 includes: a housing 70a; a drive motor 70b that is an electric motor as a drive source and a speed reducer 70c configured to reduce rotation of the drive motor 70b (both the drive motor 70b and the speed reducer 70c are incorporated in the housing 70a and are not illustrated in FIG. 5); and an axle hub 70d to which the wheel 10b is attached. The wheel drive unit 70 is what is called in-wheel motor unit disposed inside the rim 10c of the wheel 10b. Like the front-wheel drive device 12F, the rear-wheel drive device 12R is a wheel drive device of an in-wheel motor type. Like the wheel drive unit 22, the wheel drive unit 70 is well known. Thus, the wheel drive unit 70 is not explained here.

Like the front-wheel drive device 12F, by supplying an electric current to the drive motor 70b, the rear-wheel drive device 12R drives the rear wheel 10R with a drive force whose magnitude corresponds to an amount of the supplied electric current, Like the front-wheel drive device 12F, there is generated, in the drive motor 70b, an electric current based on an electromotive force generated by rotation of the rear wheel 10R. By recovering the generated electric current to the power source, namely, by energy regeneration, the wheel regenerative braking force can be applied to the rear wheel 10R. In other words, by utilizing the drive motor 70b as a generator, the rear-wheel drive device 12R functions also as a wheel regenerative brake device.

Unlike the front wheel 10F, the rear wheel 10R is not provided with the friction brake device. As apparent from FIG. 2, in the wheel brake device 14 that is the friction brake device, the disc rotor 30 and the brake caliper 32 are disposed in the rim 10c. Accordingly, the wheel brake deice 14 is subject to a limitation on provision of other constituent elements in the rim 10c. In contrast, a space inside the rim 10c of the rear wheel 10R is not cluttered but relatively neat. In other words, the friction brake device is provided for only one of: each of the front wheels; and each of the rear wheels, so that the vehicle as a whole is less likely to be subject to structural limitations on the braking-force generating means. In this respect, the friction brake device is provided not for the rear wheels 10R but for the front wheels 10F in the light of an advantage that a relatively large braking force can obtained.

The rear-wheel drive device 12R as well as the front-wheel drive device 12F is a wheel drive device of an in-wheel motor type and functions also as a wheel regenerative brake device. Thus, the ABS operation by the rear-wheel drive device 12R is excellent in response for the same reasons as discussed above with respect to the front-wheel drive device 12F.

iii) Hardware Structure Relating to Control

The drive system is configured such that the four wheel drive devices 12 are provided respectively for the four wheels 10 and is capable of applying the wheel drive force and the wheel regenerative braking force to the four wheels 10 independently of each other. The brake system is configured such that the two wheel brake devices 14 are provided respectively for the two flout wheels 10F and is capable of applying the wheel friction braking force to the two front wheels 10F independently of each other.

For applying the wheel drive force and the wheel regenerative braking force to the four wheels 10 independently of each other, the drive system is configured such that the two front-wheel drive devices 12F and the two rear-wheel drive devices 12R are respectively controlled by corresponding drive electronic control units 80, as illustrated in FIG. 1. Each of the four drive electronic control units 80 will be hereinafter referred to as “drive ECU 80” and is indicated as “DR-ECU” in FIG. 1 The drive motor 22b of the wheel drive unit 22 of each front-wheel drive device 12F and the drive motor 70b of the wheel drive unit 70 of each rear-wheel drive device 12R are three-phase brushless DC motors. The drive ECU 80 as a controller for each front-wheel drive device 12F includes: an inverter as a drive circuit of the drive motor 22b; and a computer including a CPU, a ROM, a RAM, etc., for controlling an operation of the drive motor 22b via the inverter. Similarly, the drive ECU 80 as a controller for each rear-wheel drive device 12R includes: an inverter as a drive circuit of the drive motor 70b; and a computer including a CPU, a RUM, a RAM, etc., for controlling the operation of the drive motor 70b via the inverter.

For applying the wheel friction braking force to the two front wheels 10F independently of each other, the brake system is configured such that the two wheel brake devices 14 are respectively controlled by corresponding two brake electronic control units 82. Each of the two brake electronic control units 82 will be hereinafter referred to as “brake ECU 82” and is indicated as “BR-ECU” in FIG. 1. The brake motor 46 of the actuator 40 of each wheel brake device 14 is a three-phase brushless DC motor. Each brake ECU 82 functioning as a controller includes: an inverter as a drive circuit of the brake motor 46; and a computer including a CPU, a ROM, a RAM, etc., for controlling the operation of the brake motor 46 via the inverter.

The four drive ECUs 80 and the two brake ECUs 82 arc connected to a car area network or controllable area network (CAN) 84. There are connected, to the CAN 84, a central drive electronic control unit 86 for controlling the two front-wheel drive devices 12F and the two rear-wheel drive devices 12R in a centralized manner and a central brake electronic control unit 88 for controlling the two wheel brake devices 14 in a centralized manner. The central drive electronic control unit 86 will be hereinafter referred to as “central drive ECU 86” and is indicated as “CD-ECU” in FIG. 1. The central brake electronic control unit 88 will be hereinafter referred to as “central brake ECU 88” and is indicated as “CB-ECU” in FIG. 1.

The central drive ECU 86 includes, as a main constituent element, a computer including a CPU, a ROM, a RAM, etc. The central drive ECU 86 controls the two front-wheel drive devices 12F and the two rear-wheel drive devices 12R in a centralized manner based on signals from an accelerating operation amount sensor 92 configured to detect an accelerating operation amount ψ that is an operation amount of an accelerator pedal 90 as an accelerator operating member. The central brake ECU 88 includes, as a main constituent element, a computer including a CPU, a ROM, a RAM, etc. The central brake ECU 88 controls the two wheel brake devices 14a in a centralized manner based on signals from a brake operation amount sensor 96 configured to detect a brake operation amount δ that is an operation amount of a brake pedal 94 as a brake operating member.

The vehicle includes a battery 98 for supplying the electric current to the drive motors 22b of the front-wheel drive devices 12F via the corresponding drive ECUs 80, for supplying the electric current to the drive motors 70b of the rear-wheel drive devices 12R via the corresponding drive ECUs 80, for storing the regenerative energy from the drive motors 22b, 70b via the corresponding drive ECUs 80, and for supplying the electric current to the brake motors 46 of the wheel brake devices via the corresponding brake ECUs 82.

### iv) Control of Drive Force and Braking Force

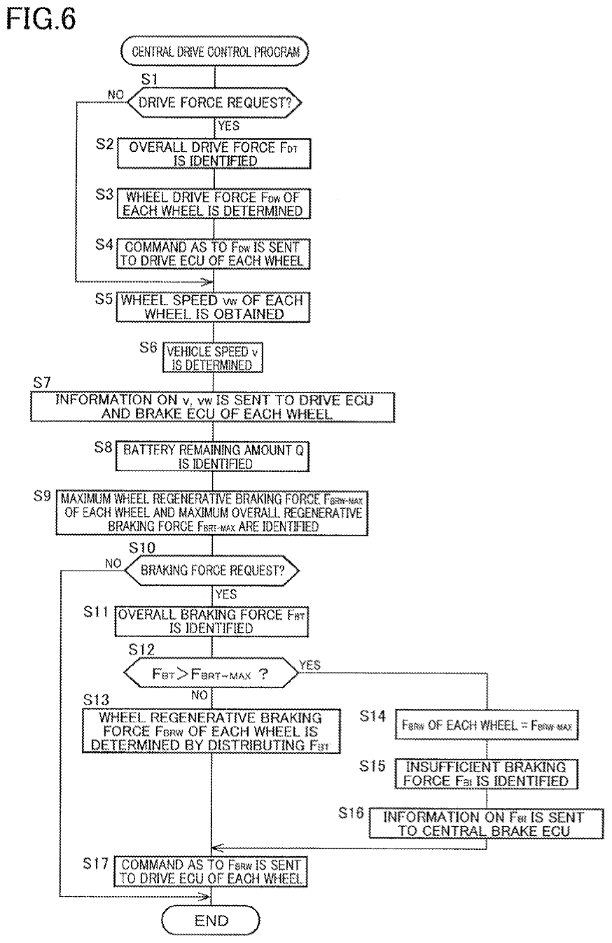

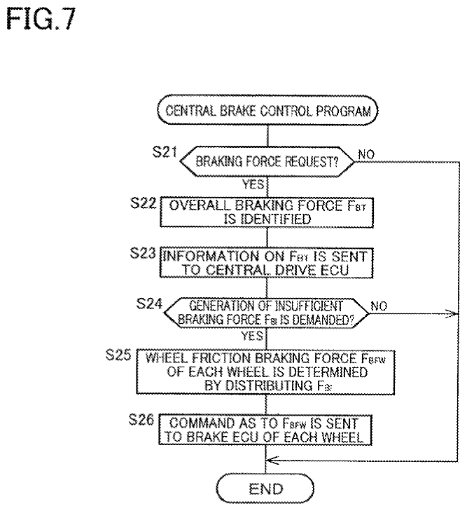

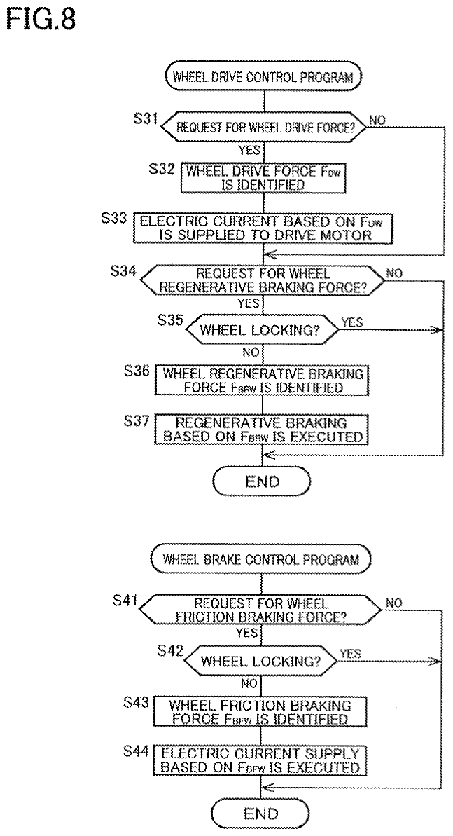

In the vehicle, the central drive ECU 86, the four drive ECUs 80, the central brake ECU 88, and the two brake ECUs 82 cooperate with each other to control a drive force F_{D} and a braking force F_{B} while transmitting and receiving information via the CAN 84. Specifically, control of the drive force F_{D} and the braking force F_{B} are executed such that the central drive ECU 86, each drive ECU 80, the central brake Fell 88, and each brake ECU 82, specifically, the computers thereof, respectively execute a central drive control program, a wheel drive control program, a central brake control program, and a wheel brake control program indicated by flow charts of FIGS. 6-8 repeatedly at a short time pitch, e.g., from several to several tens of milliseconds (msec). the control of the drive force F_{D} and the braking force F_{B} in the vehicle will be explained by explaining processing in accordance with the programs.

The central drive ECU 86 executes processing in accordance with the central drive. control program. At Step 1, the central drive ECU 86 determines whether a request for the drive force F_{D} is made in the vehicle. Hereinafter, Step 1 is abbreviated as “S1”, and other steps are similarly abbreviated. It is determined that the request for the drive force F_{D} ) is made i) in a case where the accelerator pedal 90 is being depressed by a driver and ii) in a case where a request from an automated driving system (not shown) is made when automated driving is being performed. When it is determined that the request for the drive force F_{D} is made, the control flow proceeds to S2 to identify an overall drive force F_{DT}. The overall drive force F_{DT} is the drive force F_{D} required for the vehicle as a whole. For the request for the drive force F_{D} that depends on the operation of the accelerator pedal 90, the overall drive force F_{DT} is determined based on the accelerating operation amount ψ. For the request for the drive force F_{D} that depends on the automated driving, the overall drive force F_{DT} sent from the automated driving system as information is identified. At S3, the central drive ECU 86 determines wheel drive forces F_{DW}, each of which is the drive force F_{D} that should be applied to the corresponding wheel 10, based on the overall drive force F_{DT} according to preset distribution to each wheel 10. At S4, the central drive ECU 86 sends commands as to the wheel drive forces F_{DW} respectively to the drive ECUs 80 of the respective wheels 10. When it is determined at S1 that the request for the drive force F_{D} is not made, S2-S4 are skipped.

At S5, the central drive ECU 86 obtains wheel speeds v_{w} that are rotation speeds of the respective wheels 10. Specifically, a motor rotation angle sensor (such as a resolver or a Hall IC) is provided for each of the drive motors 22b, 70b for phase switching in supplying the electric current thereto. The central drive ECU 86 obtains the wheel speed v_{w} of each wheel 10 based on information of the wheel speed v_{w} that the corresponding drive ECU 80 identifies in accordance with a motor rotation speed that depends on detection by the sensor. At S6, the central drive ECU 86 determines a running speed of the vehicle, i.e., a vehicle speed v, based on the obtained wheel speeds v_{w} of the respective wheels 10. At S7, the central drive ECU 86 sends, to each drive ECU 80 and each brake ECU 82, information as to the wheel speed v_{w} of the corresponding wheel 10 and the vehicle speed v.

At S8, the central drive ECU 86 identifies a remaining storage amount of the battery 98, i.e., a battery remaining amount Q. In other words, the central drive ECU 86 identifies how much electric quantity the battery 98 can still store therein. At 89, the central drive ECU 86 identifies maximum wheel regenerative braking forces F_{BRW-MAX}, each of which is a maximum regenerative braking force F_{BR} applicable to the corresponding wheel 10, based on the identified battery remaining amount Q and the determined vehicle speed v. By adding up the maximum wheel regenerative braking forces F_{BRW-MAX}, the central drive ECU 86 identifies a maximum overall regenerative braking force F_{BRT-MAX} that is the regenerative braking force F_{BR} applicable to the vehicle as a whole.

At S10, the central drive ECU 86 determines whether a request for the braking force F_{B} is made based on information from the central brake ECU 88. In a case where the request for the braking force F_{B} is made, the central drive ECU 86 identifies at S11 an overall braking force F_{BT} based on information sent from the central brake ECU 88. At S12, the central drive ECU 86 determines whether the identified overall braking force F_{BT} is greater than the identified maximum overall regenerative braking force F_{BRT-MAX}.

in a case where the overall braking force F_{BT} is not greater than the maximum overall regenerative braking force F_{BRT-MAX}, the control flow proceeds to S13 at which the central drive ECU 86 distributes the overall braking force F_{BT} among the wheels 10 according to the preset distribution and determines wheel regenerative braking forces F_{BRW} each of which is the regenerative braking force F_{BR} that should be applied to the corresponding wheel 10. In a case where the overall braking force F_{BT} is greater than the maximum overall regenerative braking force F_{BRT-MAX}, the control flow proceeds to S14 at which the central drive ECU 86 determines the wheel regenerative braking force F_{BRW} of each wheel 10 as the maximum wheel regenerative braking force F_{BRW-MAX}. At S15, the central drive ECU 86 identifies an insufficient braking force F_{BI} that is a shortage with respect to the overall braking force F_{BT} not provided by the maximum overall regenerative braking force F_{BRT-MAX}. At S16, the central drive ECU 86 sends, to the central brake ECU 88, information as to the insufficient braking force F_{BI}.

At S17, the central drive ECU 86 sends, to the drive ECU 80 of each wheel 10, a command as to the determined wheel regenerative braking force F_{BRW}. In this respect, when it is determined at S10 that the request for the braking force F_{B} is not made, S11 and subsequent steps are skipped. As apparent from S11 and subsequent steps, in the present vehicle, the regenerative braking force E_{BR} is generated in preference to the braking force F_{B} applied by the brake system, i.e., the friction braking force F_{BF}, in terms of energy saving.

The central brake ECU 88 executes processing in accordance with the central brake control program. At S21, the central brake ECU 88 determines whether the request for the braking force F_{B} is made in the vehicle. Specifically, it is determined that the request for the braking force is made i) in a case where the brake pedal 94 is being depressed by the driver and ii) in a case where a request from the automated driving system is made when the automated driving is being performed. When it is determined that the request for the braking force F_{B} is made, the control flow proceeds to S22 to identify an overall braking force F_{BT}. The overall braking force F_{BT} is the braking force F_{B} required for the vehicle as a whole. For the request for the braking force F_{B} that depends on the operation of the brake pedal 94, the overall braking force F_{BT} is determined based on the brake operation amount δ. For the request for the braking force F_{B} that depends on the automated driving, the overall braking force F_{BT} sent from the automated driving system as information is identified. At S23, the central brake ECU 88 sends, to the central drive ECU 86, information on the overall braking force F_{BT}.

At S24, the central brake ECU 88 determines whether generation of the insufficient braking force F_{BI} that should be compensated for by the friction braking force F_{BF} is demanded, based on information on the insufficient braking force F_{BI} sent from the central drive ECU 86. When generation of the insufficient braking force F_{BI} is demanded, the central brake ECU 88 determines at S25 wheel friction braking forces F_{BFW}, each of which is the friction braking force F_{BF} that the brake system should generate in the corresponding wheel 10, so as to distribute the insufficient braking force F_{BI} between the wheels 10. At S26, the central brake ECU 88 sends commands as to the determined wheel friction braking forces F_{BFW} respectively to the brake ECUs 82 of the corresponding wheels 10 according to preset distribution. When it is determined at S21 that the request for the braking force is not made and when it is determined at S24 that generation of the insufficient braking force F_{BI} is not demanded, steps subsequent to those determinations are skipped.

The drive ECU 80 of each wheel 10 executes processing in accordance with the wheel drive control program. At S31, each drive ECU 80 determines whether the wheel drive force F_{DW} should be applied to the corresponding wheel 10, based on information on the wheel drive force F_{DW} sent from the central drive ECU 86. When application of the wheel drive force F_{DW} is requested, the drive ECU 80 identifies at S32 the wheel drive force F_{DW} based on the information and supplies at S33 an electric current based on the lied drive force F_{DW} to the drive motor 22b, 70b the wheel drive device 12.

At S34, the drive ECU 80 determines whether the wheel regenerative braking force F_{BR} is requested to be applied to the corresponding wheel 10, based on information on the wheel regenerative braking force F_{BRW} sent from the central drive ECU 86, When application of the regenerative braking force I′ₘ is requested, the drive ECU 80 determines at S35 whether locking is occurring in the corresponding wheel 10, based on information on the wheel speed v_{w} and the vehicle speed v sent from the central drive ECU 86. When it is determined that the locking is not occurring, the drive ECU 80 identities at S36 the wheel regenerative braking force F_{BRW} to be applied and executes at S37 regenerative braking by the drive motor 22b, 70b based on the identified wheel regenerative braking force F_{BRW}. When it is determined at S35 that the locking is occurring in the wheel 10, the regenerative braking force F_{BR} is not applied to the wheel 10. That is, even if the regenerative braking force F_{BR} is currently being applied to the wheel 10, the regenerative braking force F_{BR} being applied is canceled when the wheel 10 locks. In this way, the ABS operation is performed. When it is determined at S31 that application of the wheel drive force F_{DW} is not requested, S32 and S33 are skipped. When it is determined at S34 that application of the wheel regenerative braking force F_{BRW} is not requested, subsequent steps are skipped.

The brake ECU 82 of each wheel 10 executes processing in accordance with the wheel brake control program. At S41, each brake ECU 82 determines whether the wheel friction braking force F_{BF} is requested to be applied to the corresponding wheel 10, based on information on the wheel friction braking force F_{BFW} sent from the central brake ECU 88. When application of the friction braking force F_{BF} is requested, the brake ECU 82 determines at S42 whether kicking is occurring in the corresponding wheel 10, based on information on the wheel speed v_{w} and the vehicle speed v sent from the central drive ECU 86. When it is determined that the locking is not occurring, the brake ECU 82 identifies at S43 the wheel friction braking force F_{BFW} to be applied and supplies at S44 an electric current based on the wheel friction braking force F_{BFW} to the brake motor 46 of the wheel brake device 14. When it is determined at S42 that the locking is occurring in the wheel 10, the friction braking force F_{BF} is not applied to the wheel 10. That is, even if the friction braking force F_{BF} is currently being applied to the wheel 10, the friction braking force F_{BF} being applied is canceled when the wheel 10 locks. In this way, the ABS operation is performed. When it is determined at S41 that application of the wheel friction braking force F_{BFW} is not requested, subsequent steps are skipped.

The wheel drive device 12 is configured to apply the regenerative braking force F_{BR} independently to only a corresponding one of the wheels 10, and the wheel brake device 14 is configured to apply the friction braking force F_{BF} independently to only a corresponding one of the wheels 10. Thus, the ABS operation can be performed individually for the wheels 10 in the vehicle.

### Second Embodiment

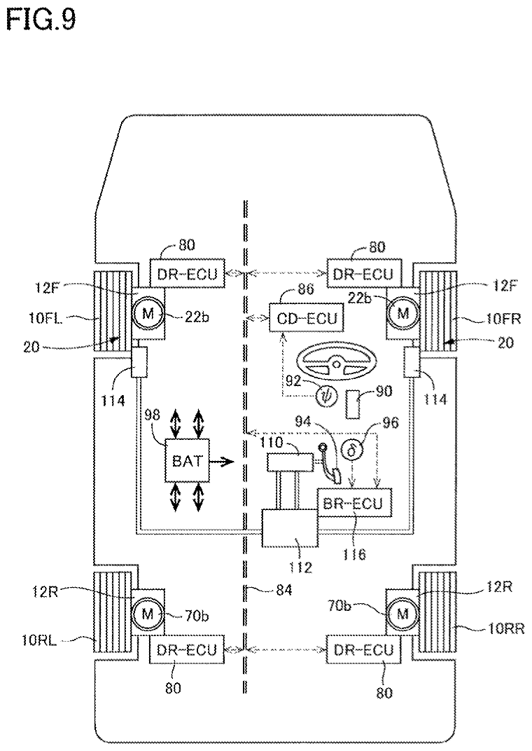

As schematically illustrated in FIG. 9, a vehicle according to a second embodiment differs from the vehicle according to the first embodiment only in the brake system. In the second embodiment, the same reference numerals as used in the first embodiment are used to identify the corresponding constituent elements, and explanation thereof is dispensed with.

The brake system of the vehicle according to the second embodiment is a hydraulic brake system configured to operate in dependence on a pressure of a working fluid. The brake system includes (a) a master cylinder 110 to which the brake pedal 94 is coupled, (b) a working-fluid supply device 112 configured to allow the working fluid from the master cylinder 110 to pass therethrough so as to supply the working fluid or configured to adjust the pressure of the working fluid pressurized by its pump (that will be described) so as to supply the working fluid, (c) two wheel brake devices 114 provided respectively for the front right and left wheels 10F and configured to decelerate rotation of the front right and left wheels 10F by the pressure of the working fluid supplied from the working-fluid supply device 112, and (d) a brake electronic control unit 116 for controlling the brake system. The brake electronic control unit 116 will be hereinafter referred to as “brake ECU 116” where appropriate and is indicated as “BR-ECU” in FIG. 9. It may be considered that one brake device is constituted by the master cylinder 110, the working-fluid supply device 112, and the two wheel brake devices.

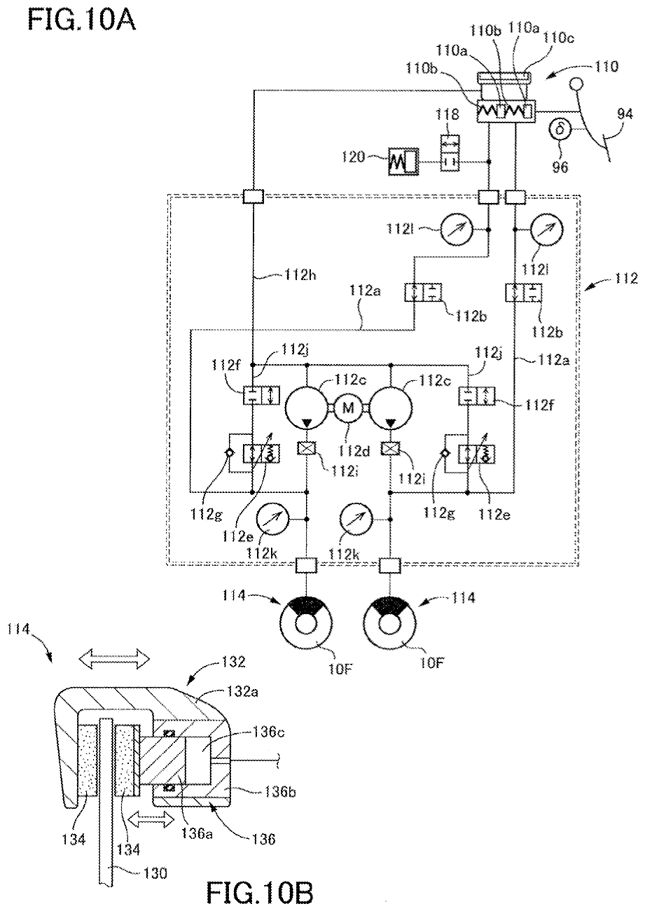

Referring to a hydraulic circuit diagram of FIG. 10A, the brake system will be briefly explained. The master cylinder 110 is a tandem cylinder device including, in its housing, two pistons 110a arranged in series and connected to the brake pedal 94, and two pressurizing chambers 110b in each of which the working fluid that has been introduced thereinto is pressurized by a movement of a corresponding one of the pistons 110a. A reservoir 110c, which stores the working fluid under the atmospheric pressure, is attached to the master cylinder 110. The master cylinder 110 is configured to supply, to the working-fluid supply device 112, the working fluid whose pressure corresponds to a force applied to the brake pedal 94 (hereinafter referred to as “brake operation force” where appropriate), for respective two systems corresponding to the two front wheels 10F.

The working-fluid supply device 112 includes: two master fluid passages 112a through which the working fluid supplied from the master cylinder 110 flows toward the respective wheel brake devices 114; two master cut valves 112b, each as a normally-opened electromagnetic open/close valve, configured to open and close the respective two master fluid passages 112a; two pumps 112c each of which functions as a hydraulic pressure source and which correspond to the respective two systems; a pump motor 112d for driving the pumps 112c; two pressure holding valves 112e, each as an electromagnetic linear valve, corresponding to the respective two systems; two shut-off valves 112f, each as a normally-closed, electromagnetic open/close valve, disposed in series with the respective pressure holding valves 112e; and two check valves 112g disposed in parallel with the respective pressure holding valves 112e. The two pumps 112c are configured to pump up the working fluid from the reservoir 110c via the reservoir fluid passage 112b. Each of the pumps 112c is connected to the corresponding master fluid passage 112a on its ejection side and supplies the pressurized working fluid to the corresponding wheel brake device 114 via a part of the master fluid passage 112a. On the ejection side of each of the pumps 112c, a buffer 112i is provided for dampening a pulsing variation (pulsation) of the pressure of the working fluid ejected from the pump 112c. In the working-fluid supply device 112, there are formed two return passages 112j each of which is disposed in parallel with the corresponding pump 112c for connecting the corresponding master fluid passage 112a and the reservoir fluid passage 112h. In each of the return passages 112j, the pressure holding valve 112e and the shut-off valve 112f are provided.

In a normal operating condition (in which no electric failure is occurring), the master cut valves 112b are in the valve closed state, and the shut-off valves 112f are in the valve open state. When the pumps 112c are driven by the pump motor 112d, the working fluid in the reservoir 110c is pressurized, and the pressurized working fluid is supplied to the wheel brake devices 114. Each pressure holding valve 112e has a function of adjusting the pressure of the working fluid to be supplied to the corresponding wheel brake device 114, to a pressure corresponding to an energizing current supplied to the pressure holding valve 112e. Each pressure holding valve 112e is a pressure-decrease valve, and the working fluid passes through the pressure holding valve 112e for pressure adjustment. The working fluid that has passed through each pressure bolding valve 112e returns to the reservoir fluid passage 112h and accordingly to the reservoir 110c via the corresponding return passage 112j and the corresponding shut-off valve 112f in the valve open state. To one of the two master fluid passages 112a, a stroke simulator 120 is connected via a simulator opening valve 118 that is a normally dosed electromagnetic opera/close valve. In the normal operating condition (in which no electric failure is occurring), the simulator opening valve 118 is energized into the valve open state, so that the stroke simulator 120 works.

In an instance where the brake system is suffering from an electric failure, the master cut valves 112b are placed in the valve open state, and the shut-off valves 112f are placed in the valve closed state, so that the working fluid supplied from the master cylinder 110 to the working-fluid supply device 112 is supplied to the wheel brake devices 114. In the working-fluid supply device 112, two wheel cylinder pressure sensors 112k and two master pressure sensors 112l are provided so as to correspond to the two systems. Each wheel cylinder pressure sensor 112k is configured to detect the pressure of the working fluid to be supplied to the corresponding wheel brake device 114 (hereinafter referred to as “wheel cylinder pressure” where appropriate). Each master pressure sensor 112l is configured to detect the pressure of the working fluid supplied from the master cylinder 110.

Like the wheel brake device 14 of the vehicle according to the first embodiment, each wheel brake device 114 includes: a disc rotor 130, as a rotation body, configured to rotate together with the wheel 10; and a brake caliper 132 held by the housing 22a of the wheel drive unit 22 so as to straddle the disc rotor 130, as illustrated in FIG. 10B. The brake caliper 132 includes: a pair of brake pads 134 each as a friction member; and a brake actuator 136 fixedly held by a caliper main body 132a for pushing the brake pads 134 against the disc rotor 130. The brake actuator 136 is a hydraulic brake actuator including a piston 136a and a wheel cylinder 136b as a hydraulic cylinder. The brake actuator 136 is configured to advance the piston 136a by the pressure of the working fluid supplied to the wheel cylinder 136b.

The working fluid is supplied from the working-fluid supply device 112 to a fluid chamber 136c of the wheel cylinder 136b, and the pressure of the working fluid causes the piston 136a to advance, so that the brake pads 134 sandwich the disc rotor 130 therebetween. Owing to sandwiching the disc rotor 130 by and between the brake pads 134, the braking force utilizing the friction force is applied to the front wheel 10F. Specifically, by independently controlling the energizing current supplied to the two pressure holding valves 112e of the working-fluid supply device 112, the wheel friction braking force is applied to the two front wheels 10F independently of each other, and the wheel friction braking force applied to the two front wheels 10F is controlled independently of each other.

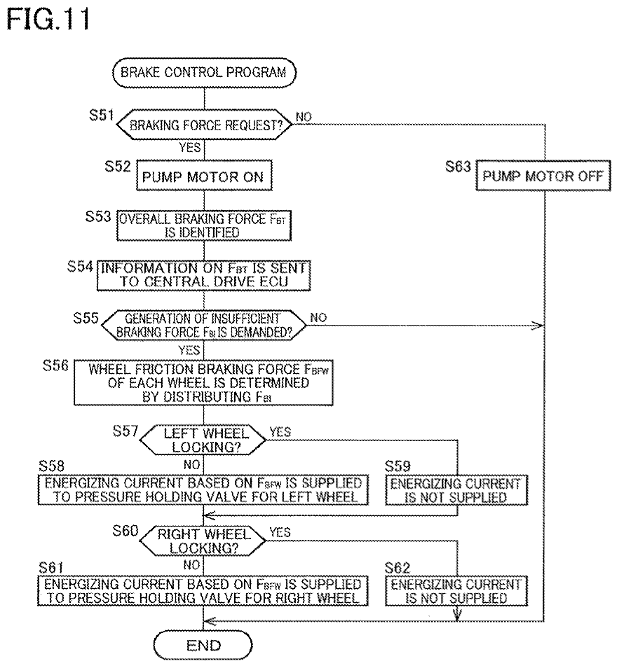

The brake ECU 116 is constituted by a computer including a CPU, a ROM, a RAM, etc., and drive circuits of the pressure holding valves 112e, the pump motor 112d, etc. of the working-fluid supply device 112. The computer repeatedly executes a brake control program indicated by a flowchart of FIG. 11 at a short time pitch, e.g., from several to several tens of milliseconds (msec), whereby the brake ECU 116 controls the wheel friction braking forces F_{BFW} applied to the two from wheels 10F.

There will be explained processing according to the brake control program. At S51, the brake ECU 116 determines whether the request for the braking force F_{B} is made in the vehicle. Specifically, it is determined that the request for the braking force F_{B} is made i) in a case where the brake pedal 94 is being depressed by the driver and ii) in a case where a request from the automated driving system is made when the automated driving is being performed. When it is determined that the request for the braking force F_{B} is made, the control flow proceeds to S52 at which the pump motor 112d of the working-fluid supply device 112 is placed in an ON state. At S53, the brake ECU 116 identifies the overall braking force F_{BT}. The overall braking force F_{BT} is the braking force F_{B} required for the vehicle as a whole. For the request for the braking force F_{B} that depends on the operation of the brake pedal 94, the overall braking force F_{BT} is determined based on the brake operation amount δ. For the request for the braking force F_{B} that depends on the automated driving, the overall braking force F_{BT} sent from the automated driving system as information is identified. At S54, the brake ECU 116 sends, to the central drive ECU 86, information on the overall braking force F_{BT}.

At S55, the brake ECU 116 determines whether generation of the insufficient braking force F_{BI} that should be compensated for by the friction braking force F_{BF} is demanded, based on information on the insufficient braking force F_{BI} sent from the central drive ECU 86. When generation of the insufficient braking force F_{BI} is demanded, the brake ECU 116 determines at S56 the wheel friction braking forces F_{BFW}, each of which is the friction braking force F_{BF} that the brake system should generate in the corresponding wheel 10, so as to distribute the insufficient braking force F_{BI} between the wheels 10. When it is determined at S55 that generation of the insufficient braking force F_{BI} is not demanded, one execution of the brake control program is ended.

At S57, the brake ECU 116 determines whether locking: is occurring in the left wheel 10 based on information on the wheel speed v_{w} and the vehicle speed v sent from the central drive ECU 86 When it is determined that the locking is not occurring, the brake ECU 116 supplies at S58 an energizing current based on the wheel friction braking force F_{BFW} to the pressure holding valve 112e corresponding to the left wheel 10. When it is determined that the locking is occurring, the control flow proceeds to S59 so as not to supply the energizing current. At S60, the brake ECU 116 determines whether locking is occurring in the right wheel 10 based on information on the wheel speed v_{w} and the vehicle speed v sent from the central drive ECU 86. When it is determined that the kicking is not occurring, the brake ECU 116 supplies at S61 an energizing current based on the wheel friction braking force F_{BFW} to the pressure holding valve 112e corresponding to the right wheel 10. When it is determined that the locking is occurring, the control flow proceeds to S62 so as not to supply the energizing current. According to the processing described above, even in a situation in which the friction braking force is being applied to the right and left wheels 10, the friction braking force F_{BF} being applied is canceled when any one of the right and left wheels 10 locks. in this way, the ABS operation is performed.

When it is determined at S51 that the request for the braking force is not made, the brake ECU 116 switches the pump motor 112d of the working-fluid supply device 112 into an OFF state, and one execution of the program by the computer is ended.

The vehicle according to the second embodiment employs the hydraulic brake system as the brake system, so that the reliability of the braking-force generating means is enhanced. Further, in the event of an electric failure in the brake system, for instance, the working fluid pressurized by the operation force applied by the driver to the brake pedal 94 is supplied to the wheel brake devices 114. Thus, the present brake system is excellent from the viewpoint of failsafe.

### Third Embodiment

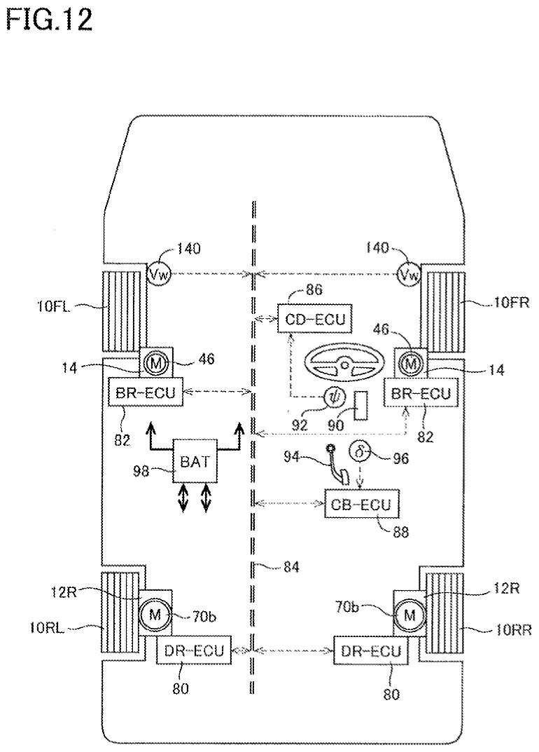

As schematically illustrated in FIG. 12, a vehicle according to a third embodiment is a rear-wheel-drive vehicle equipped with a drive system for driving only the rear wheels 10R. The vehicle of the third embodiment employs, for only the rear wheels 10R, the drive system including the rear-wheel drive devices 12R employed in the vehicle of the first embodiment. In other words, the vehicle of the third embodiment may be regarded as being equivalent to the vehicle of the first embodiment from which the front-wheel drive devices 12F are removed.

In the third embodiment, the same reference numerals as used in the first embodiment are used to identify corresponding components, and explanation of the structure of the vehicle of the third embodiment is dispensed with. Further, control of the drive force and the braking force in the third embodiment is similar to that in the first embodiment, and its explanation is dispensed with.

The drive system of the vehicle according to the third embodiment includes the two wheel drive devices 12 respectively provided for the two rear wheels 10R. The drive system is capable of applying the wheel drive force and the wheel regenerative braking force to the two rear wheels 10 independently of each other. The brake system includes the two wheel brake devices 14 respectively provided for the two front wheels 10F. The brake system is capable of applying the wheel friction braking force to the two front wheels 10F independently of each other. The drive motor 22b is not provided for each of the front wheels 10F. In this respect, two wheel speed sensors 140 are respectively provided for the front right and left wheels 10F for obtaining the wheel speeds v_{w} of the front wheels 10F. Based on signals from the wiled speed sensors 140, the determination as to occurrence of the locking of the front wheels 10F is made, for instance.

Like the vehicle of the first embodiment, the vehicle of the third embodiment includes the friction brake device for only one of: each front wheel; and each rear wheel, so that the vehicle as a whole is less likely to be subject to structural limitations on the braking force generating means. Further, the friction brake device is provided not for the rear wheels 10R but for the front wheels 10F in the light of an advantage that a relatively large braking force can be obtained. Also in the vehicle of the third embodiment, the wheel drive device 12 can apply the regenerative braking force independently to only a corresponding one of the wheels, and the wheel brake device 14 can apply the friction braking force independently to only a corresponding one of the wheels. Thus, the ABS operation can be performed individually for the wheels 10 in the vehicle. Moreover, the drive system of the vehicle according to the third embodiment is configured such that the two wheel drive devices 12 are provided respectively only for the two rear wheels 10, whereby the vehicle has the drive system simple in structure and the vehicle per se is simple in structure, as compared with the vehicle according to the first embodiment

### Fourth Embodiment

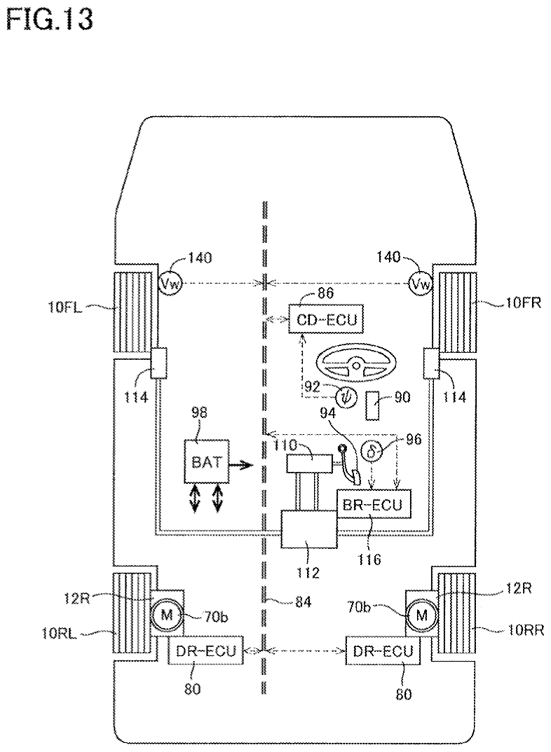

Like the vehicle according to the third embodiment, a vehicle according to a fourth embodiment is a rear-wheel-drive vehicle equipped with the drive system for driving only the rear wheels 10R, as schematically illustrated in FIG. 13. The vehicle of the fourth embodiment employs, for only the roar wheels 10R, the drive system including the rear-wheel drive devices 12R employed in the vehicle of the second embodiment. In other words, the vehicle of the fourth embodiment may be regarded as being equivalent to the vehicle of the second embodiment from which the front-wheel drive devices 12F are removed.

In the fourth embodiment, the same reference numerals as used in the second embodiment are used to identity corresponding components, and explanation of the structure of the vehicle of the fourth embodiment is dispensed with. Further, control of the drive force and the braking force in the fourth embodiment is similar to that in the second embodiment, and its explanation is dispensed with.

The drive system of the vehicle according to the fourth embodiment includes the two wheel drive devices 12 respectively provided for the two rear wheels 10R. The drive system is capable of applying, the wheel drive force and the wheel regenerative braking force to the two rear wheels 10R independently of each other. The brake system includes a hydraulic brake device provided for the two front wheels 10F. The brake system is capable of applying the wheel friction braking force to the two front wheels 10F independently of each other. As in the vehicle of the third embodiment, the drive motor 22b is not provided for each of the from wheels 10F. In this respect, the two wheel speed sensors 140 are respectively provided for the front tight and left wheels 10F for obtaining the wheel speeds v_{w} of the front wheels 10F. Based on signals from the wheel speed sensors 140, the determination as to occurrence of the locking of the front wheels 10F is made, for instance.

Like the vehicle of the second embodiment, the vehicle of the fourth embodiment includes the friction brake device for only one of: each front wheel; and each rear wheel, so that the vehicle as a whole is less likely to be subject to structural limitations on the braking force generating means. Further, the friction brake device is provided not for the rear wheels 10R but for the front wheels 10F in the light of an advantage that a relatively large braking force can be obtained. Also in the vehicle of the fourth embodiment, the wheel drive device 12 can apply the regenerative braking force independently to only a corresponding one of the wheels, and the wheel brake device 14 can apply the friction braking force independently to only a corresponding one of the wheels. Thus, the ABS operation can be performed individually for the wheels 10 in the vehicle. Moreover, the drive system of the vehicle according to the fourth embodiment is configured such that the two wheel drive devices 12 are provided respectively only for the two rear wheels 10, so that the vehicle has the drive system simple in structure, as compared with the vehicle according to the second embodiment.

Like the vehicle according to the second embodiment, the vehicle according to the fourth embodiment employs the hydraulic brake system as the brake system, so that the reliability of the braking-force generating means is enhanced. Further, as in the vehicle of the second embodiment, in the event of an electric failure in the brake system, for instance, the working fluid pressurized by the operation force applied by the driver to the brake pedal 94 is supplied to the wheel brake devices 114. Thus, the present brake system is excellent from the viewpoint of failsafe.

### Modifications

The vehicle according to the present disclosure may be achieved not only as the vehicles according to the first-fourth embodiments illustrated above but also as vehicles according to the following modifications. Detailed structure, operations, and advantages of the vehicles according, to the modifications can be understood from the explanation made above with respect to the vehicles according to the illustrated embodiments. Accordingly, in the following modifications, the same reference numerals as used in the illustrated embodiments are used to identify the corresponding components, and the vehicles according to the following modifications will be explained only in terms of the outline structure.

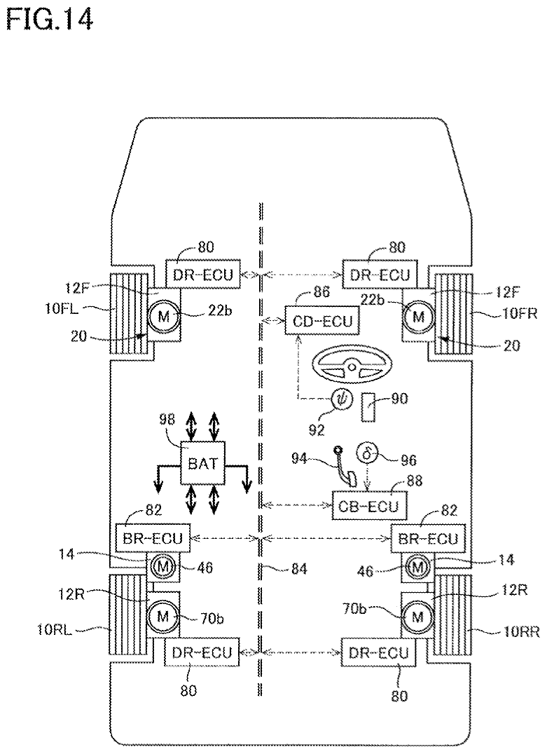

As illustrated in FIG. 14, a vehicle according to a first modification includes: the drive system including the front-wheel drive devices 12F provided for the front wheels 10F and the rear-wheel drive devices 12R provided for the rear wheels 10R; and the brake system including the electric wheel brake devices 14 provided for only the rear wheels 10R.

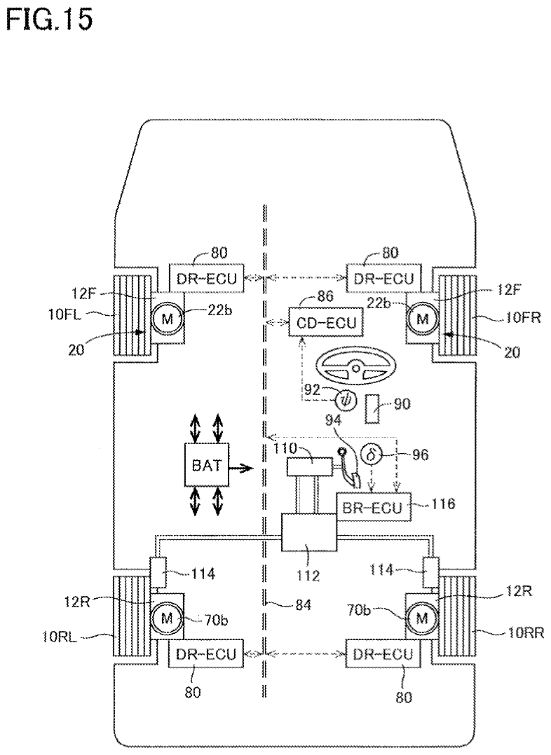

As illustrated in FIG. 15, a vehicle according to a second modification includes: the drive system including the front-wheel drive devices 12F provided for the front wheels 10F and the rear-wheel drive devices 12R provided for the rear wheels 10R; and the hydraulic brake system for applying the braking force to only the rear wheels 10R.

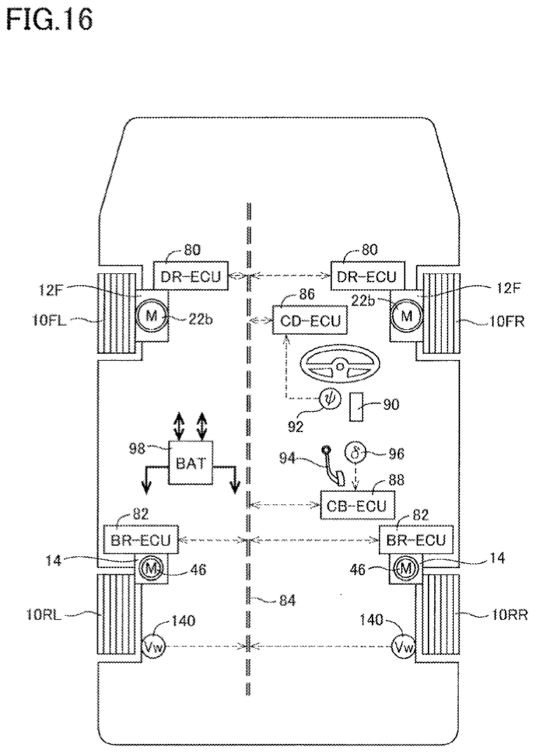

As illustrated in FIG. 16, a vehicle according to a third modification includes: the drive system including the front-wheel drive devices 12F provided for only the front wheels 10F; and the brake system including the electric wheel brake devices 14 provided for only the rear wheels 10R.

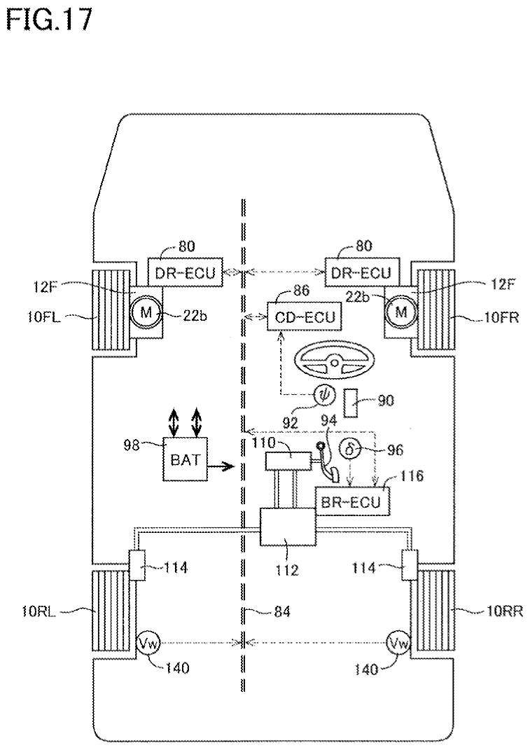

As illustrated in FIG. 17, a vehicle according to a fourth modification includes: the drive system including the front-wheel drive devices 12F provided for only the front wheels 10F; and the hydraulic brake system for applying the braking force to only the rear wheels 10R.

Went is claimed is:

1. A vehicle, comprising.:
two front wheels which are front right and left wheels and two rear wheels which are rear right and left wheels;
a brake system capable of applying a braking force to only one of (a) the two front wheels and (b) two rear wheels, independently of each other utilizing a friction force; and
a drive system configured to drive at least the other of (a) the two front wheels and (b) the two rear wheels by a force of electric motors, each as a drive source, respectively corresponding to the other of (a) the two front wheels and (b) the two rear wheels, the drive system being capable of applying a braking force to at least the other of (a) the two front wheels and (b) the two rear wheels, independently of each other utilizing regeneration by the electric motors.

2. The vehicle according to claim 1, wherein the brake system applies the braking force to the two front wheels.

3. The vehicle according to claim 1, wherein the drive system drives only the other of (a) the two front wheels and (b) the two rear wheels.

4. The vehicle according to claim 1, wherein the drive system includes a plurality of wheel drive devices of an in-wheel motor type each of which is provided for a corresponding one of the wheels driven by the drive system and in each of which the electric motor is disposed in a rim of the corresponding one of the wheels driven by the drive system.

5. The vehicle according to claim 1,
wherein the brake system includes two wheel brake devices corresponding to the right and left wheels to which the braking force is applied by the brake system, and
wherein each of the two wheel brake devices includes;
a rotation body that rotates with the wheel;
a friction member configured to be pushed against the rotation body; and
a brake actuator held by a carrier that rotatably holds the wheel and including a piston, the brake actuator being configured to advance the piston so as to push the friction member against the rotation body.

6. The vehicle according to claim 5, wherein the brake actuator includes an electric motor as a drive source, and a motion converting mechanism configured to convert a rotating motion of the electric motor into an advancing and retracting motion of the piston.

7. The vehicle according to claim 5,
wherein the brake actuator is a hydraulic brake actuator including a hydraulic cylinder configured to advance the piston by a pressure of a working fluid supplied to the hydraulic cylinder, and
wherein the brake system includes a working-fluid supply device including a hydraulic pressure source, the working-fluid supply device being configured to supply the working fluid from the hydraulic pressure source to the hydraulic cylinders of the brake actuators of the two wheel brake devices and to individually adjust the pressures of the working fluid supplied to the hydraulic cylinders.

8. The vehicle according to claim 7, wherein the brake system includes a brake operation member to be operated by a driver, the brake system being configured such that, in a failure condition of the working-fluid supply device, the working fluid to be supplied to the hydraulic cylinders is pressurized by a force applied to the brake operation member by the driver.

9. The vehicle according to claim 1, which is configured such that the braking force by the drive system is generated with higher priority in response to a braking force request and such that an insufficient braking force, which is a shortage not provided by the braking force generated by the drive system, is compensated for by the braking force generated by the brake system.

10. The vehicle according to claim 1, which is configured such that, in a case where the wheel locks in a state in which the braking force is being applied to the wheel, one of the brake system and the drive system performs an ABS operation when the one of the brake system and the drive system is applying the braking force to the wheel and both the brake system and the drive system perform the ABS operation when both the brake system and the drive system are applying the braking force to the wheel.
